(19) United States
(12) Patent Application Publication
(10) Pub. No.: US 2024/0077307 A1
(43) Pub. Date: Mar. 7, 2024

(54) DETERMINING FERRULE ORIENTATION

(71) Applicant: COMMSCOPE TECHNOLOGIES LLC, Hickory, NC (US)

(72) Inventors: Yu LU, Eden Prairie, MN (US); Joseph BLASER, Shakopee, MN (US); Antonius Bernardus Gerardus BOLHAAR, Ophemert (NL); Paul SCHNEIDER, Gemonde (NL)

(73) Assignee: COMMSCOPE TECHNOLOGIES LLC, Hickory, NC (US)

(21) Appl. No.: 17/766,996

(22) PCT Filed: Oct. 7, 2020
(86) PCT No.: PCT/US2020/054580

§ 371 Date: Apr. 6, 2022

Related U.S. Application Data
(60) Provisional application No. 62/912,147, filed on Oct. 8, 2019.

(51) Int. Cl. G01B 11/27; G02B 6/38

(52) U.S. Cl. CPC G01B 11/27; G02B 6/385; G02B 6/3885

(57) ABSTRACT

The system determines whether an orientation of a ferrule was changed between measurements made to the end face geometry of the ferrule. Accordingly, the systems allows confirmation that a ferrule was re-oriented between measurements before calculating any deviations in the measurement tool and applying corrective algorithms. An indication (e.g., alarm, error message, etc.) may be conveyed to the user to properly re-orient the ferrule.

### CROSS-REFERENCE TO RELATED APPLICATION

This application is being filed on Oct. 7, 2020 as a PCT International Patent Application and claims the benefit of U.S. Patent Application Ser. No. 62/912,147, filed on Oct. 8, 2019, the disclosure of which is incorporated herein by reference in its entirety.

### BACKGROUND

Certain types of fiber optic ferrules, such as MTP/MPO ferrules, have fiber holes for securing optical fibers therein. Signal transmission through the optical fibers can depend on precise coaxial alignment of the fibers corresponding to mating connectors. Precise positioning of the optical fibers is dependent upon the interaction between the end faces of the mating ferrules. Ferrule end faces having surface geometries outside of standard manufacturing tolerances may lead to surface interference between mating ferrules and, hence, misalignment of mating fibers. Accordingly, measurements are taken of the end face geometries of newly manufactured ferrules to determine whether standard manufacturing tolerances are met.

Several techniques for measuring the end face geometry of fiber optic ferrules exist. For example, interferometric techniques measure the relative distance among the points on the surface of the ferrule end face and then map the end face geometry, e.g. the surface profile, of the fiber optic ferrule end face. The interferometer performing the measurements uses one or more reference pins that insert into the ferrule as reference surfaces to define the axis in which the distances are measured. The precision of the measurements of the ferrules depends on the characteristics of the pin (e.g., how straight the pin is). If the pin is deformed, angled, or otherwise misaligned with the interferometer, then the measurements taken of the ferrule will be off. To account for possible deviations of the pin, the pin and interferometer can be calibrated periodically. However, calibration does not account for changes made to the pin after calibration (e.g., if a user bends the pin by inserting or removing the ferrule in a tilted direction).

An alternative technique to account for irregularity of or alteration to the pin includes taking multiple measurements of the ferrule end face in different orientations. For example, a user may position a ferrule in a first orientation relative to an interferometer, take a first measurement of the end face geometry of the ferrule, reposition the ferrule in a second orientation (e.g., rotated 180 degrees, etc.) relative to the interferometer, and take a second measurement of the end face geometry. If the pin is ideal (e.g., perfectly straight), then there is a known relationship between the measurements taken in the first orientation and the measurements taken in the second orientation. For example, if the ferrule is rotated 180 degrees, then the readings taken of the ferrule end face in the second orientation should be inverted compared to the readings taken of the ferrule in the first orientation. For example, the distance to a left-most guide opening in the first orientation should now match the distance to a right-most guide opening in the second orientation. Deviations from this expected relationship indicates an irregularity of the pin. Certain types of interferometers can calculate the deviation of the pin by this technique and apply corrective algorithms to all single side measurements afterward.

Due to user error or bad practice, measurements of a ferrule end face geometry may be taken twice without reorienting the ferrule relative to the interferometer or other measurement device. For example, a user may remove a ferrule from a mounting station of an interferometer after a first reading and inadvertently remount the ferrule at the mounting station in the same orientation. The interferometer will assume that the orientation of the ferrule was changed and will simply take the second measurement and apply the corrective algorithms based on the two obtained measurements. Accordingly, deformities of the pin will not be taken into account (at least not with accuracy) when calculating the ferrule end face geometry.

### SUMMARY

In general terms, this disclosure is directed to systems and methods for determining whether an orientation of a ferrule was changed between measurements made to the end face geometry of the ferrule. Accordingly, the disclosed systems and methods allow an interferometer or user to confirm that a ferrule was re-oriented between measurements before calculating any deviations in the pin and applying corrective algorithms. If the disclosed systems and methods determine that the ferrule was not properly re-oriented, then an indication (e.g., alarm, error message, etc.) may be conveyed to the user.

Various aspects are described in this disclosure, which include, but are not limited to, the following aspect.

In accordance with some aspects of the disclosure, a comparison is made between an overall surface profile of the ferrule end face generated from the first measurement and an overall surface profile of the ferrule end face generated from the second measurement. In certain implementations, factors that influence the surface profile of the ferrule end face include the shape of the ferrule end face and the shapes of the fibers protruding from the ferrule end face. For example, the measurements obtained of the ferrule end face can be used to determine an angle of the ferrule end face relative to a reference plane perpendicular to the interferometer or other measurement device. The measurements obtained of the protruding fibers can be used to determine a surface profile defined by the convex or concave curves of the fiber end faces.

In accordance with other aspects of the disclosure, one or more comparisons can be made between reference points along the ferrule end face and/or the protruding fibers. For example, the systems and methods can determine one or more measurement parameter differences between end face geometry measurements, and determine an orientation difference based on the measurement parameter difference.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a front perspective view of an example fiber optic ferrule.

FIG. 2 is a rear perspective view of the fiber optic ferrule of FIG. 1.

FIG. 3 is a front view of the ferrule of FIG. 1.

FIG. 4A is a front view of the fiber optic ferrule of FIG. 1 with the ferrule in a first orientation.

FIG. 4B is a front view of the fiber optic ferrule of FIG. 1 with the ferrule in a second orientation that is rotated 180 degrees with respect to the first orientation.

FIG. 5 is a bottom view of the fiber optic ferrule of FIG. 1.

FIG. 6 depicts an example core dip of an example optical fiber with the core dip being exaggerated for illustration purposes.

FIG. 7 depicts an example fiber tip radius of an example optical fiber.

FIG. 8 is a flow chart outlining a method in accordance with the principles of the present disclosure.

FIG. 9 is a top plan view of an example ferrule having a front face angled along the across the Y-axis, the ferrule being mounted relative to an example tool.

FIG. 10 is a side elevational view of an example ferrule having a front face angled along the across the X-axis, the ferrule being mounted relative to the tool.

FIG. 11 is a schematic diagram of an example system for operating the tool.

### DETAILED DESCRIPTION

Various embodiments will be described in detail with reference to the drawings, wherein like reference numerals represent like parts and assemblies throughout the several views.

Multiple measurements of a ferrule end face 120 are obtained with the ferrule 100 held in different orientations relative to the measurement tool 250 to account for irregularity of or alteration to the measurement tool 250. However, due to user error, a ferrule 100 may be not be flipped, rotated, or otherwise re-oriented between measurements. If the ferrule has not changed orientation, then the correcting algorithms will not be applied correctly. Accordingly, the systems and methods of the present disclosure analyze the obtained measurements to confirm whether the ferrule 100 was re-oriented between measurements. If the ferrule 100 was correctly re-oriented, then the systems and methods proceed as usual. If it is determined that the orientation did not change between measurements, however, an alert can be generated or an indication can otherwise be provided to the user that the end face geometry measurement is incomplete or erroneous.

In general terms, this disclosure is directed to systems and methods for determining an orientation difference of a fiber optic ferrule 100 between measurements of the end face geometry of the fiber optic ferrule end face 120. The systems and methods can determine various characteristics of the ferrule 100 based on each measurement, identity differences between the characteristics obtained from multiple end face geometry measurements, and determine whether the orientation of the ferrule 100 is different between the measurements based on the different characteristics.

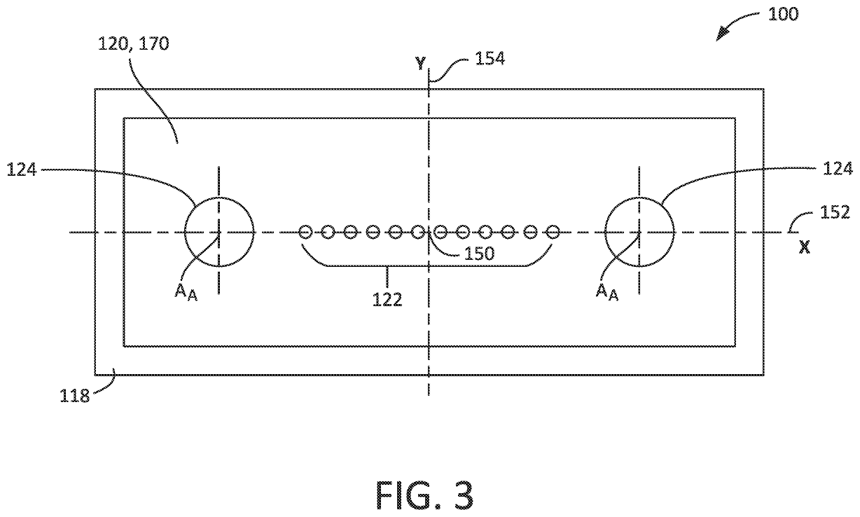

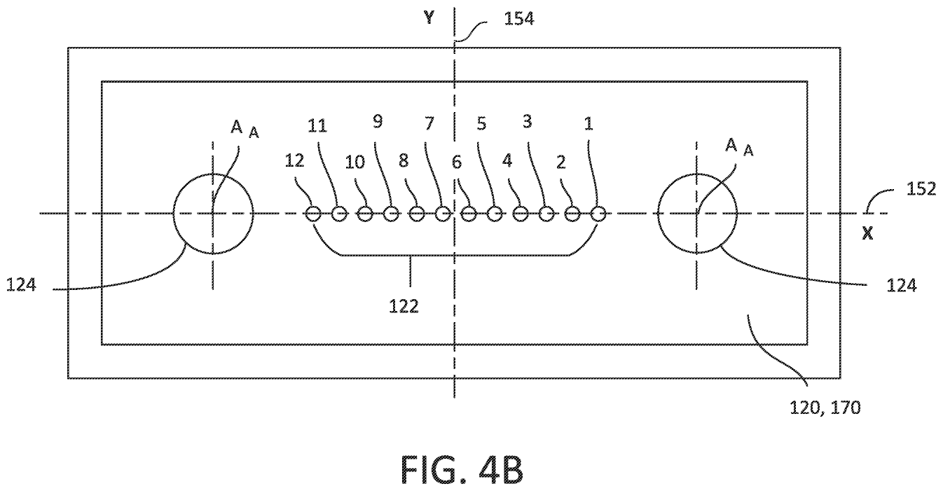

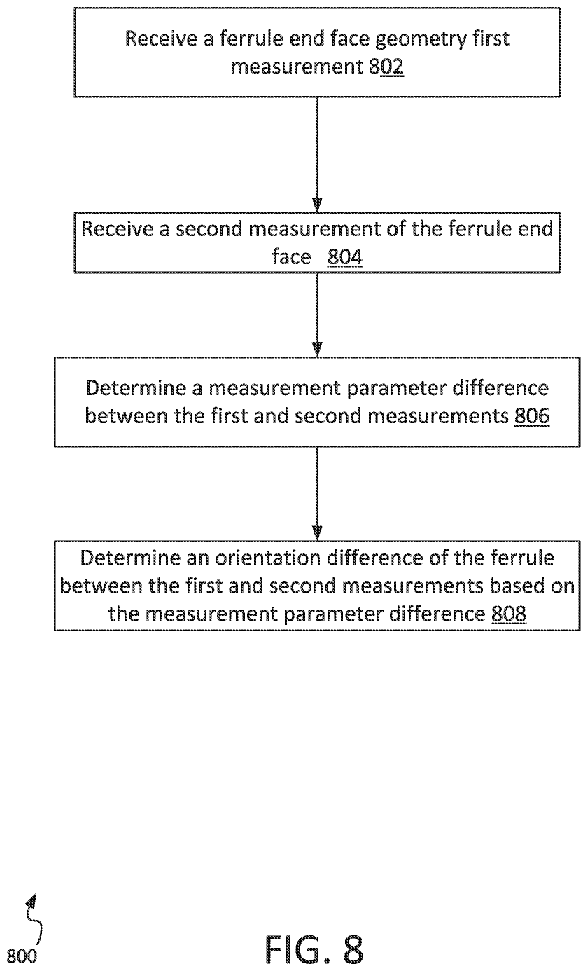

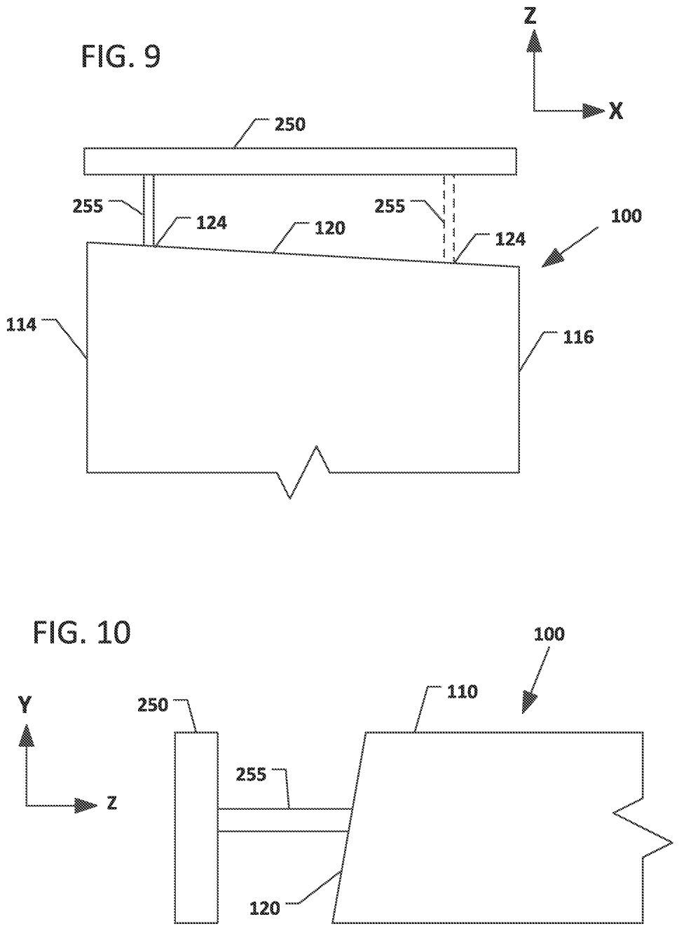

The optical ferrule 100 extends along an X-axis 152 (FIG. 3) between opposite sides 114, 116 and extends along a Y-axis 154 (FIG. 3) between a top surface 110 and a bottom surface. The optical ferrule 100 also extends along a Z-axis (FIG. 5) between a front end face 120 and a rear of the ferrule 100. Fibers 202 protrude along the Z-axis from the ferrule end face 120. The systems and methods generally measure the distance (along the Z-axis) between a measuring tool 250 (FIGS. 9 and 10) and the ferrule end face 120 at one or more points on the ferrule end face 120.

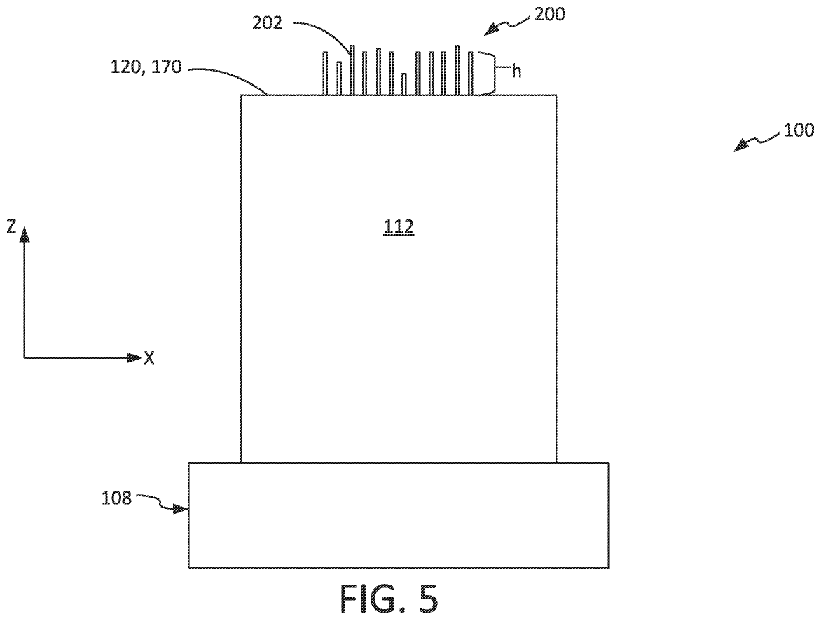

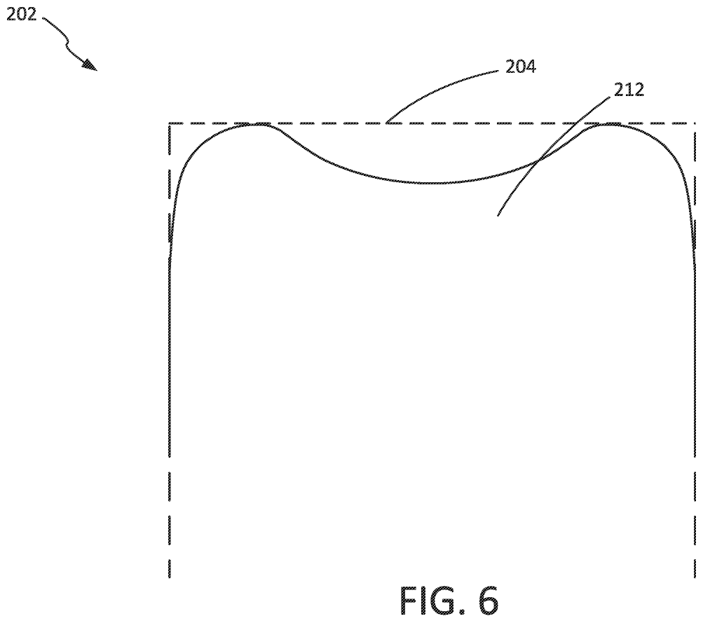

An ideal ferrule 100 will have a flat end face 120 from which fibers 202 (FIG. 5) protrude and into which alignment pin holes 124 recess. However, due to manufacturing tolerances, the ferrule end face 120 may be angled along the X-axis (e.g., see FIG. 9 where the angle is exaggerated for illustration purposes) and/or may be angled along the Y-axis (e.g., see FIG. 10 where the angle is exaggerated for illustration purposes). In an ideal ferrule 100, the fibers 202 will extend from the end face 120 at a common height and have flat tips. However, due to manufacturing tolerances, one or more fibers 202 on most ferrules will vary slightly in height. Further, the tip of each fiber 202 may have a core dip (see FIG. 6) or a radius (see FIG. 7).

The systems and methods map the relative distances among the end surface 120 and the fiber tips to obtain a surface profile for the optical ferrule 100. Based on the surface profile, the systems and methods can determine various characteristics of the ferrule 100, such as an X-axis angle of the ferrule end face 120, a Y-axis angle of the ferrule end face 120, the height of the fiber tips (e.g., the highest points along the profile), and/or the surface contour of each fiber tip (i.e., dip, radius, flat). A comparison of these characteristics from two different measurements is used to determine whether the orientation of the ferrule 100 has changed between the measurements. For example, when a predetermined number of the characteristics remains constant (or within a predetermined threshold) between the two measurements, then the ferrule 100 is determined to be unlikely to have been flipped.

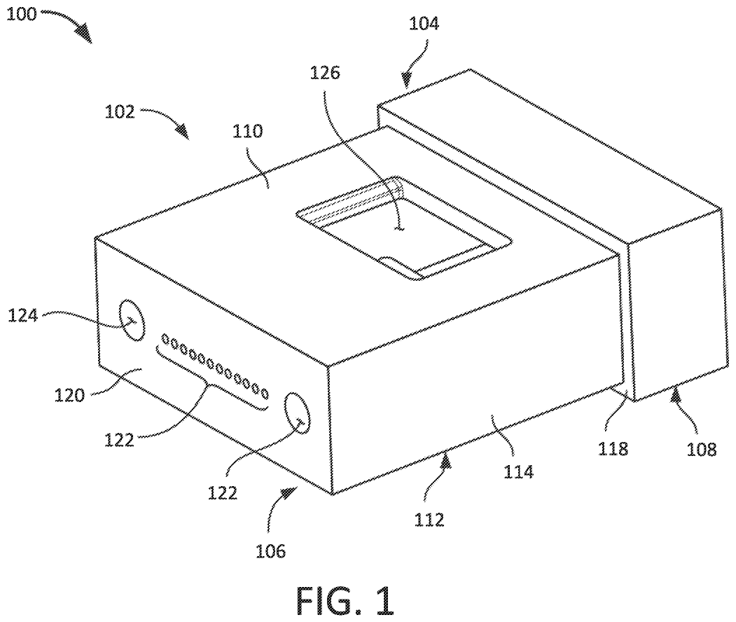

Referring to FIGS. 1-3, an example multi-fiber fiber optic ferrule 100 that can be measured using methods in accordance with the principles of the present disclosure is depicted. In one example, the ferrule 100 is a multi-fiber ferule such as an MPO ferrule adapted to support a plurality of optical fibers 202 (see FIG. 5, where the projection lengths of the fibers are exaggerated for illustration purposes) in one or more rows. The fibers 202 are typically secured by adhesive within fiber openings 122 that extend through the ferrule 100 along a forward to rearward orientation. The ferrule 100 has a forward end face 120 at which the plurality of fiber holes 122 terminate. The ferrule 100 also includes one or more alignment pin holes 124 (i.e., alignment holes or openings) that extend through the ferrule 100 in the forward to rearward orientation. The ferrule 100 also defines an adhesive window 126. The end face 120 can be perpendicular relative to the fiber holes 122, or can be orientated at an angle (e.g., less than an 8 degree angle) with respect to perpendicular.

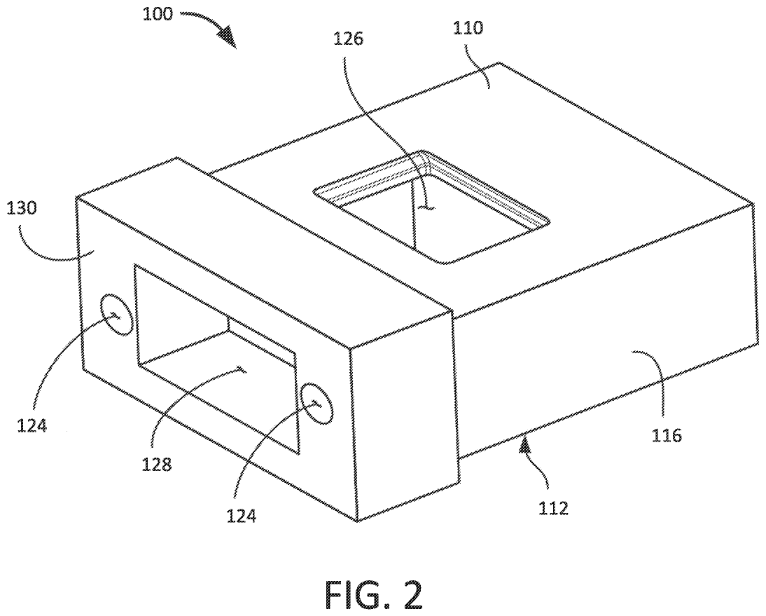

The fiber holes 122 are defined in the ferrule 100 to be in communication with a fiber insertion opening 128 (FIG. 2) at the rear of the ferrule 100. The fiber holes 122 are configured to receive optical fibers, respectively, that are inserted into the ferrule body 102 through the fiber insertion opening 128. The fiber holes 122 are open at the forward end face 120 of the ferrule body 102. When receiving the optical fibers, the fiber holes 122 expose tip ends of bare fibers at the forward end face 120. The plurality of fiber holes 122 is arranged along a line at the forward end face 120 of the ferrule 100 so as to form a row of optical fibers. The plurality of fiber holes 122 can be arranged multiple lines such as two lines. A ferrule boot can mount in the opening 128 to assist in containing adhesive within the ferrule 100.

As indicated above, one or more alignment pin holes 124 are provided at the forward end face 120 of the ferrule 100 to receive guide pins (not shown) that are configured to align two mating ferrules 100. The alignment pin holes 124 can also referred to herein as guide pin holes.

The adhesive window 126 is provided on the upper surface 110 of the ferrule 100 and in communication with at least a portion of the fiber holes 122 within the ferrule body 102. The adhesive window 126 is configured to receive adhesive (e.g., epoxy adhesive) to fix the optical fibers to the fiber holes 122.

The fiber optic ferrule 100 can be made of synthetic resin. For example, the ferrule 100 is formed by transfer molding using thermosetting resin such as an epoxy resin, injection molding using thermoplastic resin such as polyphenylene sulfide resin (PPS) or liquid crystal polymer (LCP). The resin can include glass-filled resin. Other materials can be used to form the ferrule 100.

As shown in FIGS. 9 and 10, the ferrule 100 is mounted relative to the measurement tool 250 (e.g., an interferometer) so that a pin 255 of the measurement tool 250 extends into one of the alignment pin holes 124 of the ferrule 100. In certain implementations, the tool 250 may have two pins 255 that each extend into a respective one of the alignment pin holes 124. The tool 250 takes distance measurements along an axis defined by the pin 255. In ideal systems, the pin 255 extends perfectly transverse to the measurement tool 250. Due to manufacturing tolerances and/or damage, however, the pin 255 may not be perfectly perpendicular to the measurement tool 250. Re-orienting the ferrule 100 (e.g., flipping the ferrule 180 degrees) between measurements allows the system to apply corrective algorithms to the obtained data to counteract the measurement axis not being exactly perpendicular to the measurement tool 250. However, the system confirms that the ferrule 100 was re-oriented before applying the corrective algorithms.

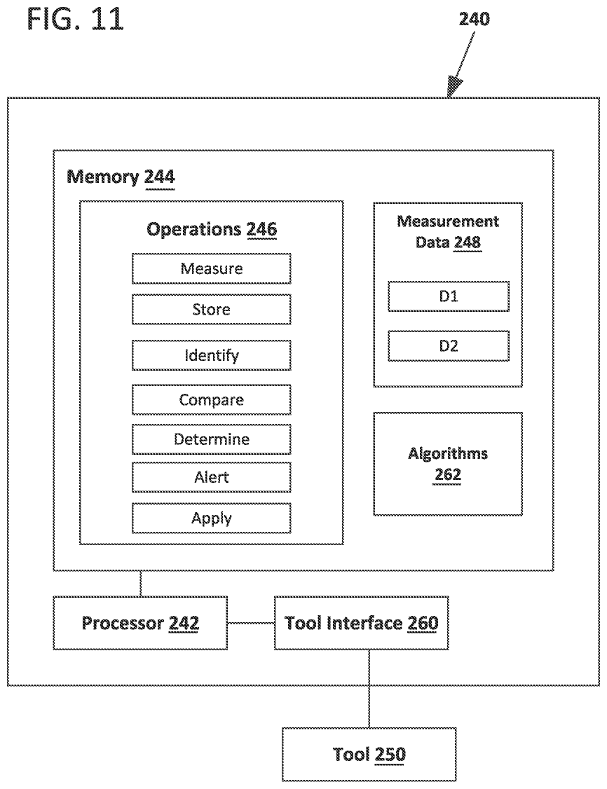

Referring to FIG. 11, an example system 240 includes a processor 242, memory 244, and a tool interface 260 by which the processor 242 controls the tool 250. In alternative systems, the tool 250 can include the processor 242 and/or the memory 244. The memory 244 stores operations 246 to be performed and measurement data 248 obtained from the tool 250. The memory 244 also may store the corrective algorithms 262 to be applied to the measurement data.

In certain implementations, the operations 246 performed by the system 240 include a measurement operation during which measurement data of a ferrule end face is obtained, a store operation in which the obtained measurement data is stored (see data 248), and an identify operation in which the obtained measurement data is analyzed to determine one or more characteristics of the surface profile of the end face. The operations 246 also may include a compare operation, during which the measurement data and/or the determined characteristics of two or more obtained measurement data are compared, and a determine operation during which the system 240 decides whether the comparison indicates the ferrule has been re-oriented. The operations 246 also may include an alert operation by which an indication is provided to the user that the ferrule 100 was not re-oriented and an apply operation by which the corrective algorithms 262 are applied to the obtained measurement data if the ferrule 100 was re-oriented.

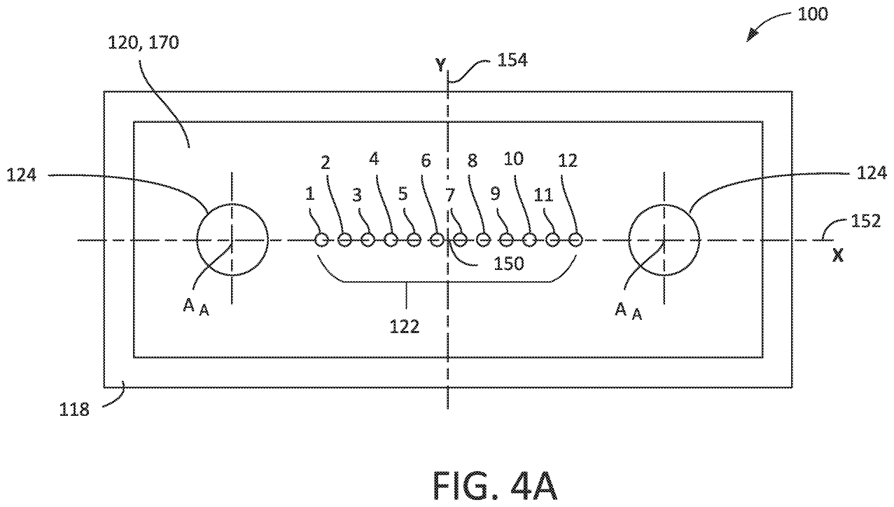

FIG. 3 is a front view of the ferrule 100, illustrating the forward end face 120 of the ferrule 100. As noted above, one or both of the alignment pin holes 124 are used as a reference point to measure the surface profile of the ferrule end face 120 and fiber tips. FIGS. 4A and 4B are front views of the ferrule 100, illustrating a change of the orientation of the ferrule 100 from a first to a second measurement. In the example shown, the forward end face 120 of the ferrule 100 is shown from the perspective of an end face geometry measurement device, such as an interferometer. The forward end face 120 lies substantially in an X-Y plane perpendicular to the measurement axis of the interferometer, e.g. the Z axis. The individual fiber tips are numbered, in the example shown, from 1-12. In the example shown in FIG. 4A, ferrule 100 is in a first orientation about the measurement axis, as indicated by the fiber tips numbering from 1-12 from left to right, for a first measurement of the ferrule end face. In the example shown in FIG. 4B, the orientation of the ferrule 100 has been rotated by 180 degrees about the measurement axis, as indicated by the fiber tips numbering 12-1 from left to right, for a second measurement of the ferrule end face.

FIG. 5 is a bottom plan view of the ferrule 100 illustrating the heights of fibers 200 extending from the forward end face 120 of the ferrule 100 in accordance with aspects of the present disclosure. In the embodiment shown, the ferrule 100 includes multiple optical fibers 200 extending from the forward end face 120 of the ferrule along the Z axis. In the example shown, the individual fibers 202 extend from the forward end face 120 by a plurality of heights h. In some embodiments, it is very unlikely that the heights of the individual fibers, e.g. fibers 1-12 illustrated in FIGS. 4A-4B, are of exactly the same height, or that the fibers that are symmetric about the measurement axis, e.g. fibers 2 and 11 and analogous pairs illustrated in FIGS. 4A-4B, are the same height to within the measurement error of the profilometer, e.g. an interferometer. In some embodiments, the height difference of a fiber position can be used to determine whether the orientation of the ferrule 100 was changed between the first and second measurements. For example, the system 240 may compare the height of one or more of the fiber positions between two sets of measurements. In certain examples, if the height of the fiber in position 1 does not change (or changes only within a predetermined tolerance), then the system 240 may determine that the ferrule has not been flipped. In certain examples, the heights of additional fiber positions are compared (e.g., two positions, three positions, four positions, five positions, six positions, twelve positions, all positions, etc.). The system 240 may determine that the ferrule is not flipped based on the heights not changing (or changing within a predetermined threshold) for a predetermined number of the fiber positions (e.g., two, three, four, five, six, twelve, all, etc.). In some embodiments, each of the heights of all of the fiber positions can be used to determine whether the orientation of the ferrule 100 was changed between the first and second measurements.

In certain implementations, the system 240 does not identify specific fiber positions. Rather, the system 240 maps an overall fiber height profile across the X-axis and compares the overall fiber height profile between the two measurement data sets. If the ferrule 100 is flipped 180 degrees between measurements, then the fiber height profile between the two measurements should be generally inverted (within a predetermined threshold). If the ferrule 100 is not flipped between measurements, then the fiber height profile should be generally the same (within a predetermined tolerance).

In certain implementations, the surface profile for one or more of the fiber tips can be determined from the measurement data. For example, by measuring the surface of the fiber tip, the system 240 can determine whether the fiber tip is flat, dipped, or radiused. FIG. 6 is a cross-sectional view of the end portion of an individual fiber 202, in accordance with some embodiments. In the example shown, the fiber 202 can be mounted in one of the fiber holes 122 of the ferrule 100, and has a core dip fiber end face surface profile 212, with respect to an idealized flat surface 204. In some embodiments, the core dip of a fiber can be determined from the forward end face 120 measurement of the ferrule 100, and is determined based on a fit of the fiber end face profile 212 with an idealized parabola. FIG. 7 is a cross-sectional view of the end portion of an individual fiber 202, in accordance with some embodiments. In the example shown, and similar to the illustration of FIG. 6, the fiber 202 can be mounted in one of the fiber holes 122 of the ferrule 100, and has a core tip radius to the fiber end face surface profile 212, with respect to an idealized flat surface 204. In some embodiments, the core tip radius of a fiber can be determined from the forward end face 120 measurement of the ferrule 100, and is determined based on a fit of the fiber end face profile 212 with an idealized parabola. In certain implementations, the surface profile is not identified for each fiber tip, but rather an overall surface profile is mapped along the X-axis. These overall surface profiles are compared by the system 240 to determine whether or not the ferrule 100 has been re-oriented.

The surface profile of one or more of the fiber tips can be used to determine whether the ferrule 100 orientation was changed between first and second measurements. For example, the system 240 may identify that fiber position 1 in a first data set has a core dip while fiber position 1 in a second data set has a radius, a flat surface, or a differently shaped core dip. In such an example, the system 240 may conclude that the ferrule 100 was flipped. In another example, the system 240 may determine that the surface profile at fiber position 1 has not changed (or has not changed beyond a predetermined threshold) between the two data sets. In such an example, the system 240 may determine that the ferrule 100 has not been flipped. In other embodiments, the surface profile of two or more of the fibers tips (e.g., two tip profiles, three tip profiles, four tip profiles, five tip profiles, six tip profiles, twelve tip profiles, all tip profiles, etc.) are compared. The system 240 may determine that the ferrule 100 is not flipped based on the surface profile not changing (or changing within a predetermined threshold) for a predetermined number of the fiber tips (e.g., two, three, four, five, six, twelve, all, etc.).

FIG. 9 shows an exaggerated surface angle of the fiber end face 120 that crosses the Y-axis 154. FIG. 10 shows an exaggerated surface angle of the fiber end face 120 that crosses the X-axis 152. If the ferrule 100 is flipped 180 degrees between measurements, then the X-axis angle and Y-axis angle of the ferrule end face 120 would be expected to change (e.g., to reverse) between measurement sets. Accordingly, the angle (e.g., X-axis angle, Y-axis angle, or a combination thereof) of the ferrule end face 120 can be used to determine whether the ferrule orientation was changed between first and second measurements. For example, the system 240 may identify that the ferrule end face angles at 0.5 degrees relative to perpendicular as the ferrule end face 120 extends from left to right in the first measurement. If, in a second measurement, the system 240 identifies the end surface 120 as angling at 0.5 degrees (or within a predetermined threshold from 0.5 degrees) from left to right, then the system 240 may conclude that the ferrule 100 was not flipped. If, in the second measurement, the system 240 identifies the end surface 120 as angling at 0.5 degrees (or within a predetermined threshold from 0.5 degrees) from right to left, however, then the system 240 may conclude that the ferrule 100 was flipped. Similarly, the system 240 may identify that the ferrule end face angles at 2 degrees relative to perpendicular as the ferrule end face 120 extends from top to bottom in the first measurement. If, in a second measurement, the system 240 identifies the end surface 120 as angling at 2 degrees (or within a predetermined threshold from 2 degrees) from top to bottom, then the system 240 may conclude that the ferrule 100 was not flipped. If, in the second measurement, the system 240 identifies the end surface 120 as angling at 2 degrees (or within a predetermined threshold from 2 degrees) from bottom to top, however, then the system 240 may conclude that the ferrule 100 was flipped.

In certain implementations, the system 240 determines that a ferrule 100 has not been flipped only when the system 240 determines little to no differences between two or more determined characteristics of the ferrule 100. In an example, the system 240 may determine that a ferrule 100 has not been flipped when the Y-axis angle of the ferrule end face and the fiber heights do not vary (or vary only between predetermined thresholds) between measurements. In another example, the system 240 may determine that a ferrule 100 has not been flipped when the X-axis angle of the ferrule end face and the fiber heights do not vary (or vary only between predetermined thresholds) between measurements. In another example, the system 240 may determine that a ferrule 100 has not been flipped when the X-axis angle of the ferrule end face and the Y-axis angle do not vary (or vary only between predetermined thresholds) between measurements. In another example, the system 240 may determine that a ferrule 100 has not been flipped when one of the angles of the ferrule end face 120 and the surface profile of one or more of the fiber tips do not vary (or vary only between predetermined thresholds) between measurements. In another example, the system 240 may determine that a ferrule 100 has not been flipped when the fiber height of one or more of the fibers 202 do not vary (or vary only between predetermined thresholds) between measurements and the surface profile of one or more of the fiber tips do not vary (or vary only between predetermined thresholds) between measurements.

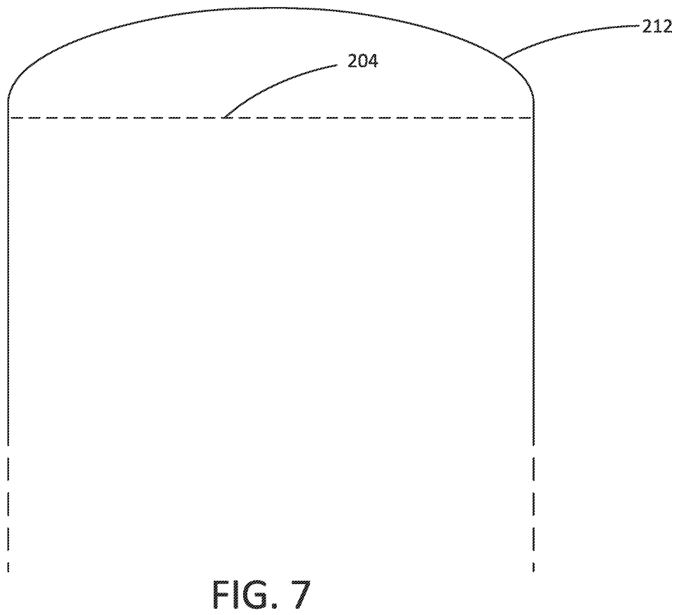

FIG. 8 is a flowchart illustrating an example method 800 of determining an orientation difference of a multimode fiber optic ferrule measurement, in accordance with aspects of the present disclosure.

At operation 802, a first measurement of the end face geometry of a ferrule 100 is received. In some embodiments, the end face measurement can be performed by an interferometer, in other embodiments the end face measurement can be performed by a contact profilometer. In general, any method to obtain a surface profile of the end face of the ferrule 100 can be used at the operation 802. In some embodiments, the end face geometry of the ferrule includes mounted fibers, such as the fibers 200 as illustrated and described above with respect to FIGS. 4-6.

At operation 804, a second measurement of the end face geometry of the ferrule 100 is received. In some embodiments, the end face measurement can be performed by the same method or profilometer as the first end face geometry measurement. For example, the second measurement of the end face geometry can be performed by an interferometer, with the orientation of the ferrule 100 being changed between the first and second measurements such as by rotating the ferrule 100 by 180 degrees about the measurement axis of the interferometer.

At operation 806, differences between the ferrule end face geometry obtained from the first and second measurements of the ferrule end face 120 are determined. In certain implementations, one or more characteristics of the ferrule end face geometry are identified and compared. In some embodiments, a characteristic of the ferrule end face geometry includes any of the X-axis angle, Y-axis angle, fiber height, fiber height profile, fiber tip surface profile, or fiber tips surface profile. Differences in characteristics can include a difference in any of the X-axis angle, the Y-axis angle, the individual fiber heights, the fiber height profiles, the individual fiber tip profiles, or the overall fiber tip surface profile of the first and second measurements. For example, a characteristic difference could be a positive X-axis or Y-axis angle, or both, in a first measurement and a negative X-axis or Y-axis angle, or both, of the same or different magnitude in the second measurement.

At operation 808, an orientation difference of the ferrule 100 between the first and second measurements can be determined based on the determined end face geometry differences. Differences in ferrule characteristics, as determined at operation 806, indicate that the orientation of the ferrule 100 has changed between the first and second measurements. A lack of such characteristic differences, or differences below a threshold level, can indicate that the orientation of the ferrule 100 did not change between the first and second measurements.

In some implementations, a determination that the ferrule has been flipped if a predetermined number of the ferrule characteristics change beyond predetermined thresholds. In other implementations, a difference in one characteristic beyond a predetermined threshold may overcome a lack of differences in others of the characteristics. For example, a dramatic change in fiber height or fiber height profile may overcome a finding of a common X-axis angle and Y-axis angle, thereby allowing the system 240 to identity that a ferrule 100 was re-oriented even if the ferrule end face is substantially flat (i.e., the X-axis and/or Y-axis angles are too small to be accurately read by the tool 250). In another example, inverted fiber tip surface profiles between the two readings may overcome a lack of determined difference in fiber height profiles (e.g., if the fibers 202 generally extend to a common height).

The various examples and teachings described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

1. A method of determining a measurement orientation difference of a fiber optic ferrule measurement, the method comprising:
receiving a first end face geometry measurement of the fiber optic ferrule;
receiving a second end face geometry measurement of the fiber optic ferrule;
determining a difference between the first and second end face geometry measurements; and
determining whether an orientation of the fiber optic ferrule during the first end face geometry measurement is different than the orientation of the multimode fiber optic ferrule during the second end face geometry measurement based on the determined difference.

2. The method of claim 1, further comprising providing a fault indication if the orientation of the fiber optic ferrule during the first end face geometry measurement is not different than the orientation of the fiber optic ferrule during the second end face geometry measurement.

3. The method of claim 1, further comprising providing a pass indication if the orientation of the fiber optic ferrule during the first end face geometry measurement is different than the orientation of the fiber optic ferrule during the second end face geometry measurement.

4. The method of claim 1, wherein the difference includes a difference in a height of one or more fibers.

5. The method of claim 1, wherein the difference includes a difference in a fiber height profile.

6. The method of claim 1, wherein the difference includes a difference in a fiber tip profile between the first and second end face geometry measurements.

7. The method of claim 1, wherein the difference includes a difference in an X-axis angle of an end face of the fiber optic ferrule.

8. The method of claim 1, wherein the difference includes a difference in a Y-axis angle of an end face of the fiber optic ferrule.

9. The method of claim 1, wherein the first orientation the fiber optic ferrule is a 180 degree rotation about the measurement axis from the second orientation the fiber optic ferrule.

10. The method of claim 1, wherein the end face geometry measurement of the fiber optic ferrule is performed by an interferometer.

11. The method of claim 10, wherein the interferometer has a measurement axis substantially perpendicular to the end face of the fiber optic ferrule.

12. The method of claim 10, wherein the interferometer is configured to hold the fiber optic ferrule in a first orientation about the measurement axis during the first end face geometry measurement and is configured to hold the fiber optic ferrule in a second orientation about the measurement axis during the second end face geometry measurement.
